(19) United States
(12) Patent Application Publication
(10) Pub. No.: US 2003/0105679 A1
(43) Pub. Date: Jun. 5, 2003

(54) Point of sale terminal arrangement using television set-top box

(76) Inventors: Aditya Krishnan, San Diego, CA (US); Matthew S. Chang, San Diego, CA (US); Andrew M. Proehl, San Francisco, CA (US); David K.L. Yang, San Jose, CA (US); Fred J. Zustak, Poway, CA (US); Peter Rae Shintani, San Diego, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/753,446

(22) Filed: Jan. 3, 2001

(51) Int. Cl. G06F 17/60

(52) U.S. Cl. 705/27

(57) ABSTRACT

A television set-top box used as a point of sale terminal at a retail establishment such as a department store or kiosk. The television set-top box may include a swipe card reader and is coupled to a television display, an input device and a printer. The customer accesses a catalog database of merchandise and inventory using a user interface to point of sale software. The customer may also enter an order using order entry software forming a part of the point of sale software. The catalog database is situated on a disc drive within the set-top box and can be updated from a catalog server as required to maintain accurate inventory and merchandise information in one embodiment. In another embodiment, the set-top box operates in a client mode to access information from the catalog server.

### CROSS REFERENCE TO RELATED DOCUMENTS

This application is related to docket number SNY-P4152, Ser. No. ______ filed of even date herewith to Krishnan et al, entitled “Set-Top Box with Credit Card Reader and Method of Activation/Authentication” having common assignee, which is hereby incorporated herein by reference.

### FIELD OF THE INVENTION

This invention relates generally to the field of point of sale terminals. More particularly, this invention relates to a television set-top box used as a point of sale terminal in a store.

### BACKGROUND OF THE INVENTION

In shopping centers, malls, kiosks and department stores, it is common that not all merchandise available for purchase can be made available for display for customers. In many instances, customization of certain merchandise is needed before it can be purchased. For example, window treatments must generally be made or cut to order so that the correct size can be provided. It is generally impractical to provide all sizes and styles at a single retail outlet due to space constraints and the cost of stocking. As a result, certain merchandise might only be available as a catalog order. In such cases, the retail outlet frequently provides conventional paper catalogs for viewing by the consumer so that purchase decisions can be made.

The use of such catalogs is often cumbersome and the catalogs can easily be damaged, lost or out of date. Moreover, there is generally no mechanism for a consumer to determine the status of inventory of such catalog merchandise without involvement of a sales representative.

Television set-top boxes were initially introduced to provide tuning capabilities for cable and satellite television systems. While these devices still provide that fundamental function, digital set-top boxes now often incorporate powerful computers in the latest generation of set-top boxes. With such computers available, and with the low cost necessitated by the high volume production of such devices, it is now possible to expand the usefulness of the television set-top box beyond that of merely providing tuning functions for cable and satellite systems.

### SUMMARY OF THE INVENTION

The present invention relates generally to a television set-top box used as a point of sale terminal. Objects, advantages and features of the invention will become apparent to those skilled in the art upon consideration of the following detailed description of the invention.

In one embodiment of the present invention, a television set-top box used as a point of sale terminal at a retail establishment such as a department store or kiosk. The television set-top box may include a swipe card reader and is coupled to a television display, an input device and a printer. The customer accesses a catalog database of merchandise and inventory using a user interface to point of sale software. The customer may also enter an order using order entry software forming a part of the point of sale software. The catalog database is situated on a disc drive within the set-top box and can be updated from a catalog server as required to maintain accurate inventory and merchandise information in one embodiment. In another embodiment, the set-top box operates in a client mode to access information from the catalog server.

In another embodiment consistent with the invention, a point of sale terminal arrangement, includes a television set-top box having an internal programmed processor. A display is coupled to the set-top box for displaying output from the set-top box. An input device such as a keyboard or mouse is provided to provide input commands to the set-top box. A database is operatively coupled to the internal programmed processor. The database includes a catalog of merchandise available for purchase by a consumer. A catalog program operates on the programmed processor, to permit a consumer to search the database for merchandise.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a system block diagram of a system using a set-top box.

FIG. 2 is a functional block diagram of a digital set-top box suitable for use with the present invention.

FIG. 3 is a system block diagram of a television set-top box used as a point of sale terminal.

FIG. 4 illustrates a simplified software architecture for implementing an embodiment of the prevent invention.

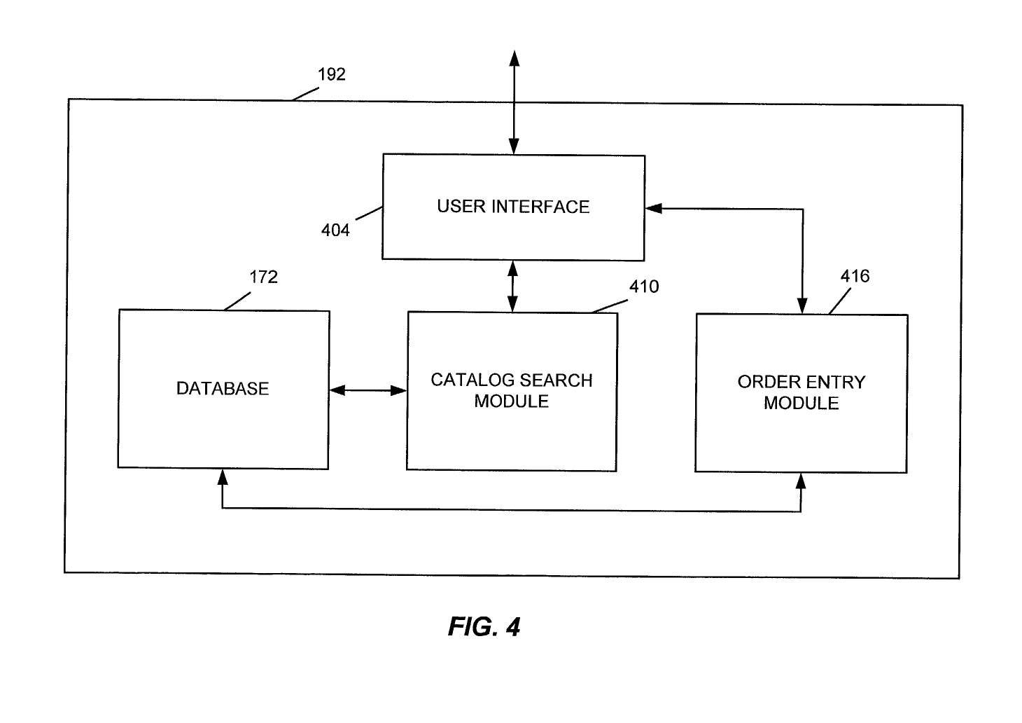

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

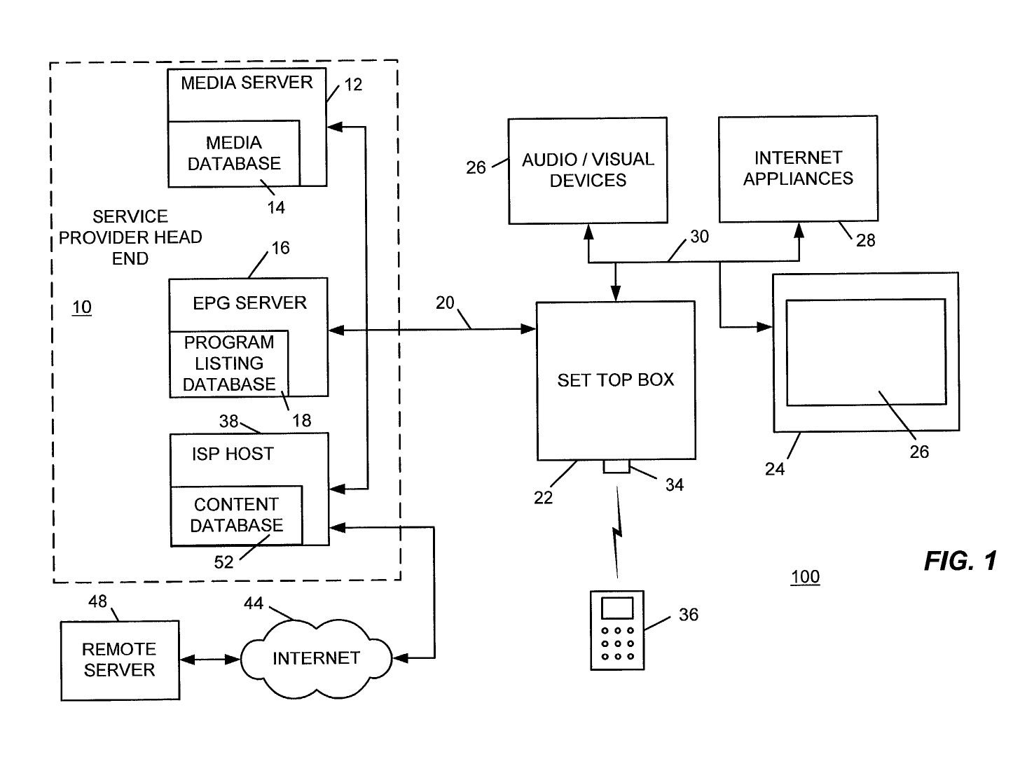

Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet.

The media server 12 and EPG server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, an EPG, etc. The STB 22 may be coupled to the TV 24 and various other audio/visual devices 26 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 1 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 1 may actually reside in other locations, but from the perspective of the user of STB 22, the service provider 10 serves as a portal to the services shown. Those skilled in the art will appreciate that the illustration of FIG. 1 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Those details can be found in the publicly available CableLabs OpenCable™ specification or in the text “OpenCable Architecture (Fundamentals)” by Michael Adams, Cisco Press, November 1999.

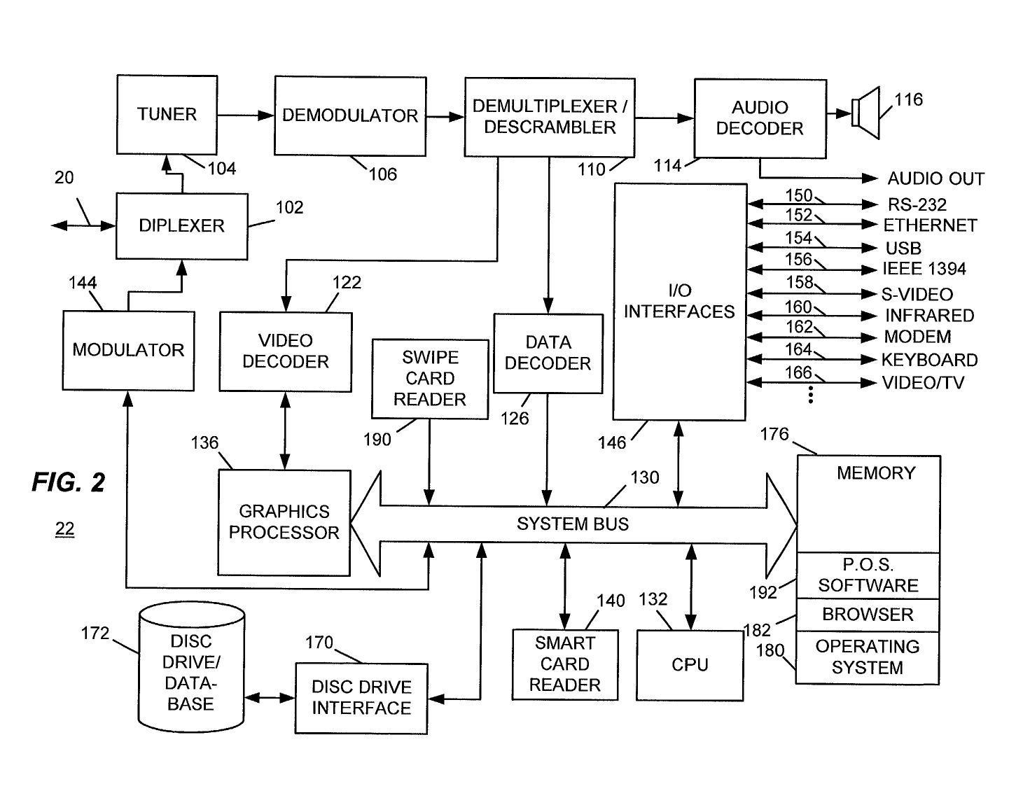

Referring now to FIG. 2, a typical system configuration for a digital set-top box 22 is illustrated. In this exemplary set-top box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-link™) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bidirectional communication via the DOCSIS cable modem with the STB 22 being identified by a unique IP address. The DOCSIS specification is publically available.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD R/W drives) DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system 180 such as, for example, Sony Corporation's AperioS™ real time operating system is loaded into, or is permanently stored in, active memory along with the appropriate drivers for communication with the various interfaces. In other embodiments, other operating systems such as Microsoft Corporation's Windows could be used without departing from the present invention. Along with the operating system and associated drivers, the STB 22 usually operates using browser software 182 in active memory or may permanently reside in ROM, EEPROM or Flash memory, for example. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware,” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside (e.g., browsing, email, EPG, Video On Demand (VOD), rich multimedia applications, pay per view, etc.). The current invention can be utilized with any suitable set-top box software and hardware architecture. In a conventional home environment wherein a set-top box 22 is used as a tuning mechanism for a cable or satellite television system, the arrangement shown in FIG. 1 provides for the user to receive programming and other services from the service provider 10. In accordance with the present invention, the television set-top box 22 is placed in service as a simple point of sale terminal used to facilitate a customer's access to merchandise that would normally be available in paper catalogs.

In accordance with embodiments of the present invention, the set-top box 22 of FIG. 2 includes a credit card reader or swipe card reader 190—that is, a card reader for reading a magnetic swipe card such as a credit card or debit card. While this credit card reader 190 is illustrated as an integral part of STB 22, the present invention can also be realized with a separate external credit card reader coupled to a suitable interface 146. In the context of the present invention, the terms “credit card” and “swipe card” are used to generically and equivalently describe a credit card, debit card, automated teller card, smart card or other card using conventional magnetic stripe encoding or magnetic stripe interface. The present invention also contemplates use of future “electronic purse” type devices that can operate, from a user's perspective, in a similar manner as a credit card to permit purchases via a line of credit or by debiting an account. All such devices are considered equivalent herein and will be referred to using the common terms “credit card” or “swipe card”. In a similar manner, smart-card reader 140 can be considered equivalent to credit card reader 190 to the extent that the smart card read by reader 140 can be used for purchases of goods and services in a manner similar to that used online with a credit card. In addition, the set-top box is equipped with point of sale software 192 stored in the STB 22's memory 176, or in the disc drive 172. Disc drive 172 also carries a database of products, including specifications and photographs used to replace a customer's use of paper catalogs.

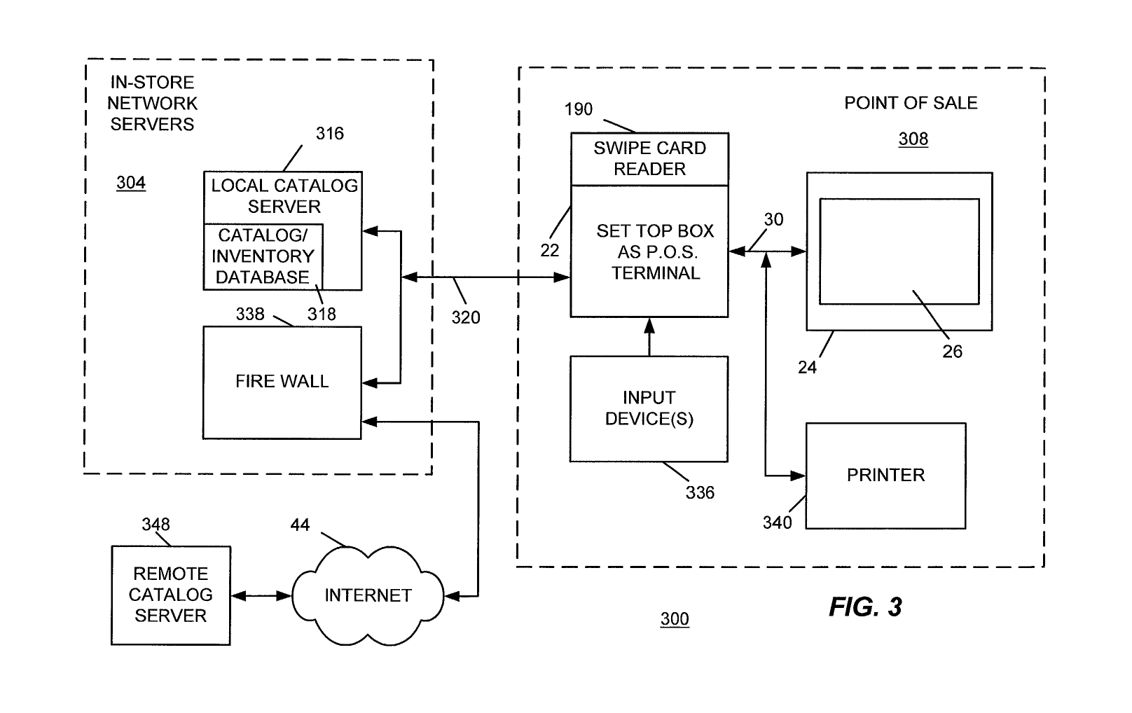

With reference to FIG. 3, a system architecture for use of STB 22 as a basis for a point of sale terminal is illustrated with an in store network of servers 304 providing a basis for supporting a point of sale 308. Set-top box 22 is connected to a television 24 having display 26 as an output device for viewing by customers. In preferred embodiments, this display can advantageously be a large screen television display, and may in fact be a high definition television. An input device 336 such as a mouse or other pointing device and a keyboard is provided to facilitate the customer's search of an electronic catalog. A printer may also be provided if desired in order to print orders if order taking is implemented in such a terminal.

The point of sale 308 is coupled via a connection (e.g. a cable television like connection) 320 to the in-store catalog server 316 having a catalog and inventory database 318. Catalog server 316 may also be coupled through a fire wall 338 to the Internet 44, or equivalently a private network, to a remote catalog server 348 that serves as a central depository for inventory and catalog information for a particular enterprise.

In one embodiment, the remote catalog server 348 maintains a central database of available products and current inventory. Periodically, e.g. whenever an order is taken, the remote catalog server downloads updates to the local catalog server 316 so that the local database 318 accurately reflects current products and inventory. Similarly, local catalog server 316 may relay such updates to the database stored as 172 on STB 22, either as purchases are made or on a periodic basis (e.g. daily). In another embodiment, the STB 22 may operate in a client-server mode as a client to the local catalog server 316, accessing database 318 to provide the customer with an ability to browse merchandise and check inventory.

In other embodiments, an updating process can be carried out on a periodic basis, for example, nightly. That is, remote catalog server 348 can, on a nightly basis (or other suitable time period) download updates to the local catalog server 316. Similarly, the local catalog server 316 can download updates to the STB 22 on a periodic (e.g., nightly) basis, if the STB 22 is operating as a standalone database (rather than in a client-server mode). In this manner all types of information may be updated including inventory levels, price changes, price corrections, description corrections, description changes, rebate information, sales, new items, discontinuations of old items, closeouts, etc. This information can be easily distributed on a nightly basis or even more frequently if needed.

From a simplified software architecture point of view, one embodiment of the point of sale software 192 operating on the STB 22 may include a user interface 404 that provides the ser with a comfortable mechanism for browsing a catalog or entering an order. In one embodiment, for example, the user can search through a hierarchical system of menus to find a particular product and view illustrations, pricing, specifications, etc. thereof. A catalog search module 410 receives input from the user interface 404 and provides appropriate queries as required to the catalog database 172 (or 318) in order to navigate through the database in a manner appropriate to lead the customer to a desired product or product category. The customer can also access an order entry module 416 which is interfaced to database 172 (or 318) to effect entry of orders from the customer and appropriately adjust inventory if required. The architecture described may, for example, be similar to software used for online Internet merchants that permit their customers to browse an online catalog, except that response is near instantaneous due to the database residing within the set-top box 22 or locally in a dedicated catalog inventory database 318 connected by a high speed connections such as a cable modem connection through connection 320.

Thus an economical point of sale terminal is provided to substitute for paper catalogs for use by a sales person or consumer. The system permits the user to peruse an electronic catalog, check the availability of merchandise and place orders.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above and can be stored on an electronic storage medium. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A point of sale terminal arrangement, comprising in combination:
a television set-top box having an internal programmed processor;
a display coupled to the set-top box for displaying output from the set-top box;
an input device suitable for providing input commands to the set-top box;
a database operatively coupled to the internal programmed processor, the database comprising a catalog of merchandise available for purchase by a consumer; and
catalog program means, operating on the programmed processor, for permitting a consumer to search the database for merchandise.

2. The apparatus according to claim 1, further comprising order entry program means, operating on the programmed processor, for permitting a consumer to enter an order for merchandise appearing in the catalog of merchandise.

3. The apparatus according to claim 1, further comprising a swipe card reader coupled to the programmed processor to permit the consumer to enter a swipe card to effect payment for merchandise appearing in the catalog of merchandise.

4. The apparatus according to claim 1, wherein the input device comprises a keyboard.

5. The apparatus according to claim 1, wherein the display comprises a television display.

6. The apparatus according to claim 1, wherein the display comprises a high definition television display.

7. The apparatus according to claim 1, wherein the database resides on a storage device situated within the set-top box, and further comprising a connection to a catalog server, to thereby download updates of the catalog of merchandise to the database.

8. The apparatus according to claim 1, wherein the database resides on a catalog server, coupled to the set-top box via a cable television connection.

9. The apparatus according to claim 1, further comprising a printer coupled to the set-top box.

10. The apparatus according to claim 1, further comprising means for receiving updates to the database on a periodic basis.

11. A point of sale terminal arrangement, comprising in combination:
a digital television set-top box having an internal programmed processor;
a high definition television display coupled to the set-top box for displaying output from the set-top box;
a keyboard suitable for providing input commands to the set-top box;
a storage device situated within the set-top box;
a database residing on the storage device and operatively coupled to the internal programmed processor, the database comprising a catalog of merchandise available for purchase by a consumer;
means for receiving updates to the database on a periodic basis;
catalog program means, operating on the programmed processor, for permitting a consumer to search the database for merchandise;
order entry program means, operating on the programmed processor, for permitting a consumer to enter an order for merchandise appearing in the catalog of merchandise;
a swipe card reader coupled to the programmed processor to permit the consumer to enter a swipe card to effect payment for merchandise appearing in the catalog of merchandise;
a cable modem coupled to a catalog server, to thereby download updates of the catalog of merchandise to the database; and
a printer coupled to the set-top box.

12. A point of sale terminal arrangement, comprising in combination:
a digital television set-top box having an internal programmed processor;
a high definition television display coupled to the set-top box for displaying output from the set-top box;
a keyboard suitable for providing input commands to the set-top box;
a cable modem coupled the programmed processor to access a catalog server;
means for receiving updates to the database on a periodic basis
a storage device situated within a catalog server accessible by the set-top box using the cable modem;
a database residing on the storage device and operatively coupled to the internal programmed processor, the database comprising a catalog of merchandise available for purchase by a consumer;
means for receiving updates to the database on a periodic basis;
catalog program means, operating on the programmed processor, for permitting a consumer to search the database for merchandise;
order entry program means, operating on the programmed processor, for permitting a consumer to enter an order for merchandise appearing in the catalog of merchandise;
a swipe card reader coupled to the programmed processor to permit the consumer to enter a swipe card to effect payment for merchandise appearing in the catalog of merchandise; and
a printer coupled to the set-top box.
